(19) United States
(12) Patent Application Publication
(10) Pub. No.: US 2025/0173473 A1
(43) Pub. Date: May 29, 2025

(54) DATA CENTER CONSTRUCTION METHOD, DATA CENTER CONSTRUCTION SYSTEM, AND DATA CENTER

(71) Applicant: OBAYASHI CORPORATION, Tokyo (JP)

(72) Inventors: Akinori TSUNAWAKI, Tokyo (JP); Riki TABATA, Tokyo (JP); Hifumi IGUCHI, Tokyo (JP); Koichi NAKATSUKA, Tokyo (JP); Kazukiyo NUMATA, Tokyo (JP)

(73) Assignee: OBAYASHI CORPORATION, Tokyo (JP)

(21) Appl. No.: 18/841,970

(22) PCT Filed: Feb. 28, 2023
(86) PCT No.: PCT/JP2023/007327

§ 371 Date: Aug. 27, 2024

(30) Foreign Application Priority Data
Mar. 1, 2022 (JP) 2022- 031023

(51) Int. Cl. G06F 30/13; G06F 111/20; G06F 113/02

(52) U.S. Cl. CPC G06F 30/13; G06F 2111/20; G06F 2113/02

(57) ABSTRACT

A method for constructing a data center using an existing building includes identifying locations of beams in a first level of the existing building in which a server is placed; specifying layout options that include a server placement region that is surrounded by the beams and a floor removal region in a second level immediately above the first level, the floor removal region being directly above the server placement region; and determining, in the layout options, a layout of the data center in accordance with a weight of a server placed in the server placement region and a weight of a floor in the floor removal region.

### TECHNICAL FIELD

The present disclosure relates to a data center construction method that assists in construction of a data center, a data center construction system, and a data center.

### BACKGROUND ART

In a data center, each server generates heat by consuming a significant amount of power, necessitating considerations for the internal structure of the data center, such as air conditioning. As a result, technologies for constructing data centers using the hot aisle/cold aisle configuration are being explored (see, for example, Patent Literature 1).

Furthermore, building structures for data centers are also being considered (see, for example, Patent Literature 2). In the technology disclosed in this document, the building structure includes beams that connect first pillars of the building, and truss beams that connect second pillars within the building, which are placed at spans longer than the spans of the first pillars. An external air intake section is provided in a chimney located outside the first pillars of the building to bring in cool air from the outside.

### CITATION LIST

### Patent Literature

Patent Literature 1: Japanese Laid-Open Patent Publication No. 2014-48027

Patent Literature 2: Japanese Laid-Open Patent Publication No. 2018-162626

### SUMMARY OF INVENTION

### Technical Problem

Due to closure and other issues related to the aging of existing data center facilities, there is a shortage of urban-type data centers in urban areas. However, in urban areas, securing construction sites for building large-scale data centers poses a challenge.

Therefore, it is necessary to construct data centers efficiently.

### Solution to Problem

In one general aspect, a method for constructing a data center using an existing building includes: identifying locations of beams in a first level of the existing building in which a server is placed; specifying layout options that include a server placement region that is surrounded by the beams and a floor removal region in a second level immediately above the first level, the floor removal region being directly above the server placement region; and determining, in the layout options, a layout of the data center in accordance with a weight of a server placed in the server placement region and a weight of a floor in the floor removal region.

In another general aspect, a data center construction system includes a control unit configured to determine a layout for installing a server of a data center in an existing building. The control unit is configured to execute: identifying locations of beams in a first level of the existing building in which a server is placed; specifying layout options that include a server placement region that is surrounded by the beams and a floor removal region in a second level immediately above the first level, the floor removal region being directly above the server placement region; and outputting the layout options in accordance with a weight of a server placed in the server placement region and a weight of a floor in the floor removal region.

In a further general aspect, a data center provided in an existing building includes a server placement region that is a floor region surrounded by beams in a first level in which a server is placed in the existing building, and a floor removal region in a second level immediately above the first level. The floor removal region is a region above the server placement region and in which a floor is removed while preserving beams.

### BRIEF DESCRIPTION OF DRAWINGS

FIG. 1 is an explanatory diagram illustrating a data center construction system according to one embodiment.

FIG. 2 is an explanatory diagram illustrating a hardware configuration according to the embodiment shown in FIG. 1.

FIG. 3 is an explanatory diagram illustrating a procedure of a data center construction process according to the embodiment shown in FIG. 1.

FIG. 4A is an explanatory diagram of an existing building according to the embodiment shown in FIG. 1, illustrating a first story before renovation.

FIG. 4B is an explanatory diagram of the existing building according to the embodiment shown in FIG. 1, illustrating a second story above the first story before the renovation.

FIG. 5A is an explanatory diagram of a first layout option according to the embodiment shown in FIG. 1, illustrating the first story after the renovation.

FIG. 5B is an explanatory diagram of the first layout option according to the embodiment shown in FIG. 1, illustrating the second story after the renovation.

FIG. 6A is an explanatory diagram of a second layout option according to the embodiment shown in FIG. 1, illustrating the first story after the renovation.

FIG. 6B is an explanatory diagram of the second layout option according to the embodiment shown in FIG. 1, illustrating the second story after the renovation.

FIG. 7A is an explanatory diagram of a third layout option according to the embodiment shown in FIG. 1, illustrating the first story after the renovation.

FIG. 7B is an explanatory diagram of the third layout option according to the embodiment shown in FIG. 1, illustrating the second story after the renovation.

FIG. 8A is an explanatory diagram of a fourth layout option according to the embodiment shown in FIG. 1, illustrating the first story after the renovation.

FIG. 8B is an explanatory diagram of the fourth layout option according to the embodiment shown in FIG. 1, illustrating the second story after the renovation.

FIG. 9A is an explanatory diagram of the procedure of the data center construction according to the embodiment shown in FIG. 1, illustrating a state before the renovation.

FIG. 9B is an explanatory diagram of the procedure of the data center construction according to the embodiment shown in FIG. 1, illustrating floor removal.

FIG. 9C is an explanatory diagram of the procedure of the data center construction according to the embodiment shown in FIG. 1, illustrating installation of air conditioners.

FIG. 9D is an explanatory diagram of the procedure of the data center construction according to the embodiment shown in FIG. 1, illustrating installation of servers.

### DESCRIPTION OF EMBODIMENTS

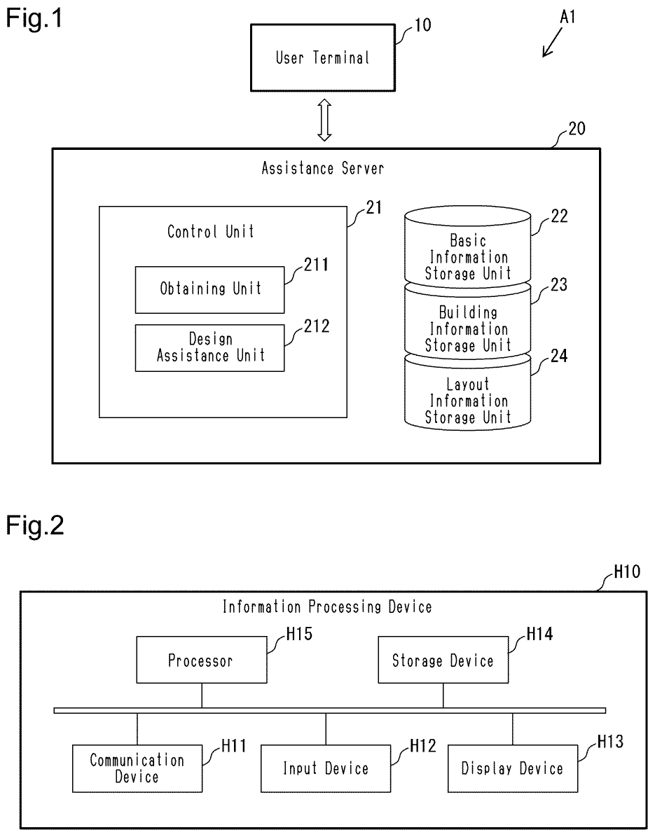

A data center construction method according to one embodiment will now be described with reference to FIGS. 1 to 9D. In the present embodiment, multiple existing office buildings are renovated to construct groups of small-scale data centers. These data center groups are then connected via dedicated lines to create a virtual large-scale data center. A data center construction method for constructing each data center in this case, a data center construction system, and a data center will be described.

In the present embodiment, as shown in FIG. 1, a data center construction system A1 utilizes a user terminal 10 and an assistance server 20, which are interconnected via a network.

### Description of Hardware Configuration

A hardware configuration of an information processing device H10, which functions as the user terminal 10 and the assistance server 20, will be described with reference to FIG. 2. The information processing device H10 includes a communication device H11, an input device H12, a display device H13, a storage device H14, and a processor H15. This hardware configuration is merely an example, and the information processing device H10 may be implemented by other hardware.

The communication device H11 is an interface that establishes communication paths with other devices so as to transmit and receive data. The communication device H11 is, for example, a network interface or a wireless interface.

The input device H12 receives input of various types of information, and is, for example, a mouse or a keyboard. The display device H13 is, for example, a display that displays various types of information. A touch screen may be used as the input device H12 and the display device H13.

The storage device H14 stores data and various programs used to perform various functions of the user terminal 10 and the assistance server 20. Examples of the storage device H14 include a read-only memory (ROM), a random-access memory (RAM), and a hard disk drive.

The processor H15 uses programs and data stored in the storage device H14 to control processes in the user terminal 10 and the assistance server 20. Examples of the processor H15 include, for example, a central processing unit (CPU) and a micro processor unit (MPU). The processor H15 expands, in RAM, programs stored in ROM or the like, so as to execute various processes.

The processor H15 is not limited to one that performs software processing on all processes executed by itself. For example, the processor H15 may include a dedicated hardware circuit (for example, an application specific integrated circuit: ASIC) that executes at least part of the processes executed by itself. Specifically, the processor H15 may be any of the following.
[1] One or more processors that operate according to a computer program (software).
[2] One or more dedicated hardware circuits that execute at least part of various processes.
[3] Circuitry including a combination of the above elements.

A processor includes a CPU and a memory, such as a RAM and a ROM, and the memory stores program codes or instructions configured to cause the CPU to execute processes. Memory or computer-readable media includes any available media that can be accessed by a general purpose or special purpose computer.

### System Configuration

Next, functions of the data center construction system Al will be described with reference to FIG. 1.

The user terminal 10 is a computer terminal used by a designer who decides the placement of servers. The designer accesses the assistance server 20 using the user terminal 10.

The assistance server 20 is a computer system that executes processes to assist in design of a data center. The assistance server 20 includes a control unit 21, a basic information storage unit 22, a building information storage unit 23, and a layout information storage unit 24.

The control unit 21 executes processes discussed below (processes including an obtainment stage and a design assistance stage). By executing processing programs for this purpose, the control unit 21 functions as an obtaining unit 211, a design assistance unit 212, and the like.

The obtaining unit 211 obtains various types of information from the user terminal 10.

The design assistance unit 212 assists in the design of a data center in which servers are placed in an existing building. It is also possible to use the building information modeling (BIM).

The basic information storage unit 22 stores information for assisting in placement of servers. In the present embodiment, the basic information storage unit 22 stores a unit weight of a floor, a unit area of a server rack, and an average weight of server racks.

The unit weight of a floor refers to the weight per unit area that is associated with the type of floor structure.

The unit area of a server rack refers to the area of a server rack of a standardized specification (for example, 19 inches).

The average weight of server racks refers to an average weight of server racks that house servers used in a data center.

The building information storage unit 23 stores building management information concerning the building that is to be renovated into a data center. When a building in which a data center is to be constructed is registered, the building information storage unit 23 stores the building management information. The building management information includes the building identifier and the design drawings for the respective levels of the building.

The building identifier is used to identify the existing building in which the data center is to be constructed.

The levels refer to the stories in the existing building where servers are to be placed.

The design drawings record information on the arrangements and sizes of the structural components of the building (the foundation, the pillars, the beams, the floor surfaces, the walls, and the like).

The layout information storage unit 24 stores layout option information for the data center to be constructed in the existing building. The layout information storage unit 24 stores layout option information when a design process is executed. The building management information includes the building identifier and layout drawings.

The building identifier is used to identify the existing building in which the data center is to be constructed.

The layout drawings are information for specifying floor remaining regions and removal regions, which will be described later, in the design drawings.

### Design Process

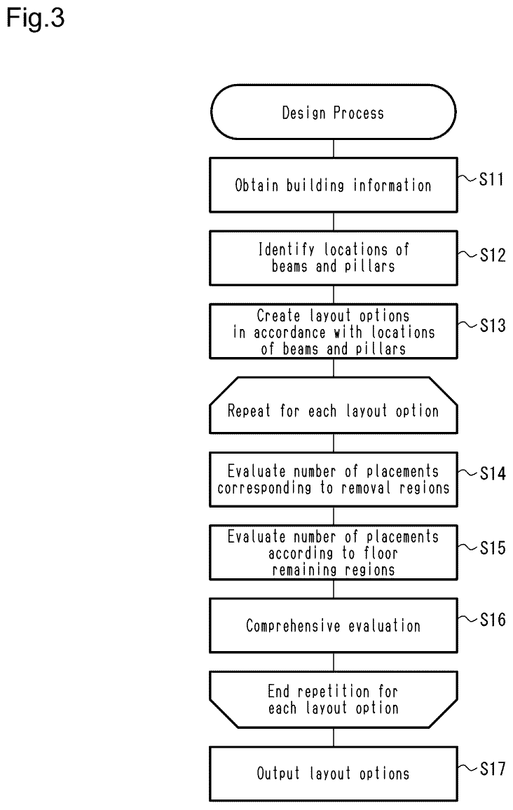

The design process will now be described with reference to FIG. 3.

First, the control unit 21 of the assistance server 20 executes a process of obtaining architectural information (step S11). Specifically, the obtaining unit 211 of the control unit 21 obtains the architectural information from the user terminal 10.

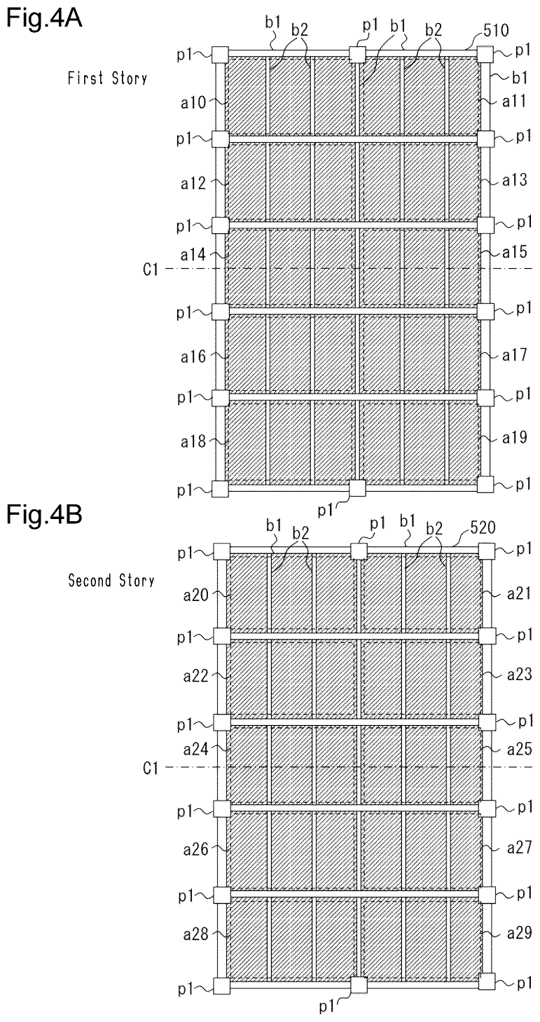

For example, a case will now be described in which a data center is constructed in an existing building using a first story 510 shown in FIG. 4A and a second story 520 shown in FIG. 4B. The first story 510 is a lower story (first level), and the second story 520 is an upper story (second level), which is immediately above the first story 510.

Next, the control unit 21 executes a process of identifying the locations of beams and pillars (step S12). Specifically, the design assistance unit 212 of the control unit 21 obtains the locations of the structural members (beams and pillars) of the levels in which servers will be installed from the architectural information.

Pillars p1, primary beams b1, and secondary beams b2 are identified in the first story 510 shown in FIG. 4A and in the second story 520 shown in FIG. 4B.

Next, the control unit 21 executes a process of creating layout options based on the locations of the beams and the pillars (step S13). Specifically, the design assistance unit 212 divides levels in which servers are to be installed into multiple floor regions.

In the present embodiment, the floor of the first story 510 is divided into regions a10 to a19, which are surrounded by the primary beams b1 and the secondary beams b2. Also, the floor of the second story 520 is divided into regions a20 to a29, which are surrounded by the primary beams b1 and the secondary beams b2.

Next, the design assistance unit 212 reserves an office space and a utility space. In the present embodiment, the office space and the utility space are provided in a different story from the first story 510 and the second story 520.

The design assistance unit 212 creates layout options that specify regions in which servers will be installed among the divided regions. In a case in which the office space and the utility space are provided in a level in which servers are to be installed, layout options are created in regions excluding the office space and the utility space.

In this case, floor remaining regions, in which the floor for placing servers is preserved, and removal regions, in which the floor is removed (floor removal region) are provided. In the exemplary first story 510, when the regions a10 to a19 are allocated to either the floor remaining region or the removal region, 1024 layout options can be created. In the present embodiment, the layout options are created under the following conditions.

Both the first story 510 and the second story 520 are provided with floor remaining regions and removal regions.

The area of the removal regions is limited to less than or equal to half of the total floor area.

The area ratio between the floor remaining regions and the removal regions is determined to fall within a specified range.

The floor remaining regions and the removal regions are arranged symmetrically with respect to a specified axis passing through the center of the levels. In the present embodiment, the floor remaining regions and the removal regions are arranged symmetrically with respect to an axis C1 in the first story.

The second story 520 above the first story 510 uses a layout in which the floor remaining regions and the removal regions are reversed compared to the first story 510.

Examples of layout options created under the above-described conditions will now be described.

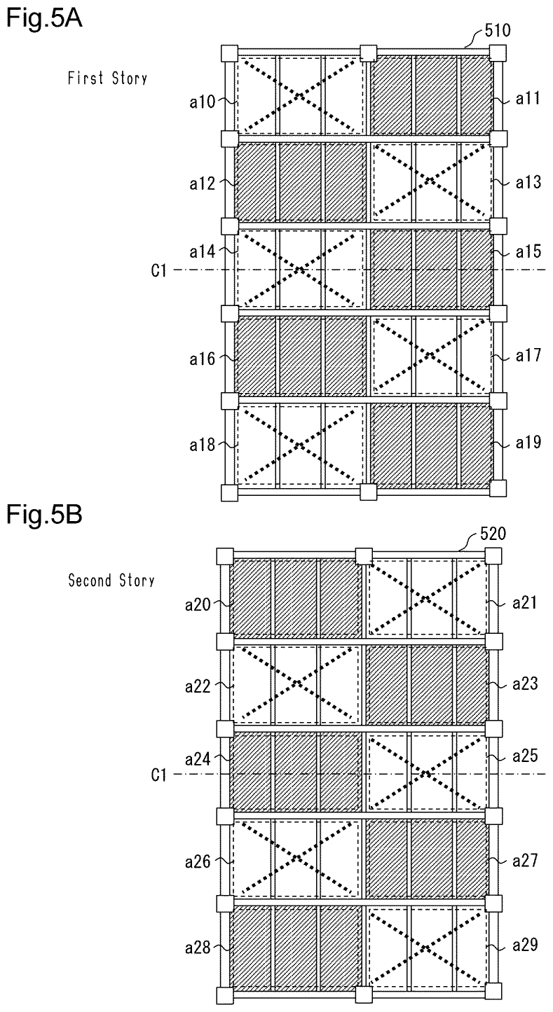

FIG. 5A shows a first layout option, in which the floor remaining regions are provided in the regions a11, a12, a15, a16, and a19 in the first story 510. The removal regions are provided in the regions a10, a13, a14, a17, and a18. In the drawings, the shaded regions indicate that the floor is preserved, and the dotted X-marked regions indicate that the floor has been removed.

In the second story 520 above the first story 510, the floor remaining regions and the removal regions are reversed compared to the first story 510 as shown in FIG. 5B. Specifically, the removal regions are provided in the regions a21, a22, a25, a26, and a29 in the second story 520. The floor remaining regions are provided in the regions a20, a23, a24, a27, and a28.

In the first layout option, the servers are placed in a dispersed manner, so that the cooling effect is improved.

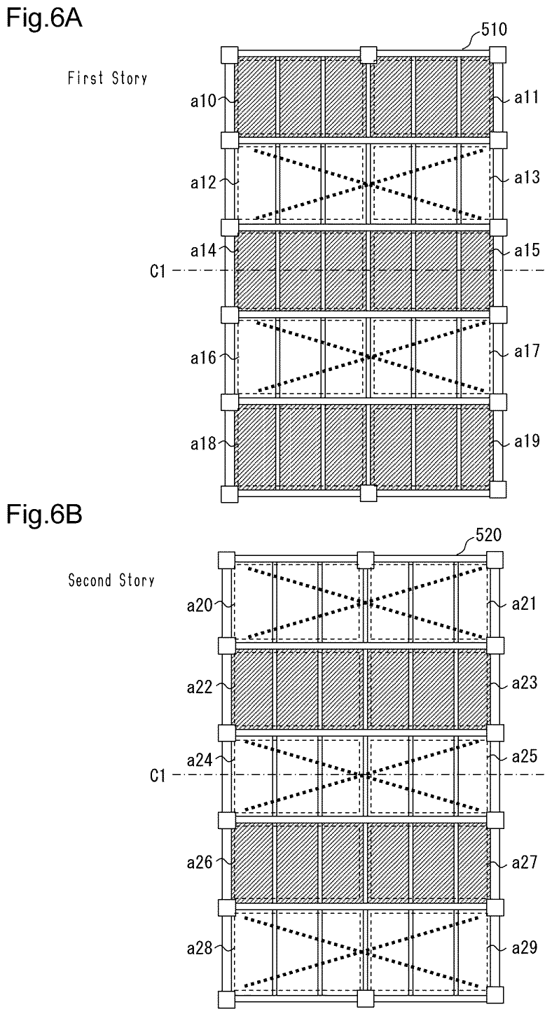

FIG. 6A shows a second layout option, in which the floor remaining regions are provided in the regions a10, a11, a14, a15, a18, and a19 in the first story 510. The removal regions are provided in the regions a12, a13, a16, and a17.

In the second story 520 above the first story 510, the floor remaining regions and the removal regions are reversed compared to the first story 510 as shown in FIG. 6B. Specifically, the removal regions are provided in the regions a20, a21, a24, a25, a28, and a29 in the second story 520. The floor remaining regions are provided in the regions a22, a23, a26, and a27.

In the second layout option, two floor remaining regions, in which servers are placed, are collectively provided, so that the cooling effect and the ease of maintenance are improved.

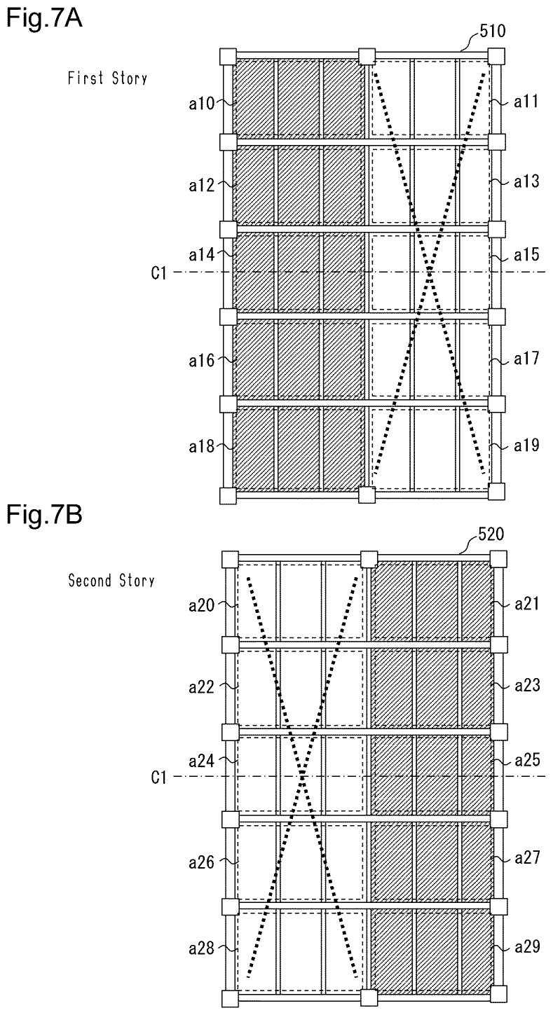

FIG. 7A shows a third layout option, in which the floor remaining regions are provided in the regions a10, a12, a14, a16, and a18 in the first story 510. The removal regions are provided in the regions a11, a13, a15, a17 and a19.

In the second story 520 above the first story 510, the floor remaining regions and the removal regions are reversed compared to the first story 510 as shown in FIG. 7B. Specifically, the removal regions are provided in the regions a20, a22, a24, a26, and a28 in the second story 520. The floor remaining regions are provided in the regions a21, a23, a25, a27, and a29.

In the third layout option, five floor remaining regions, in which servers are placed, are collectively provided, so that the cooling effect and the ease of maintenance are improved.

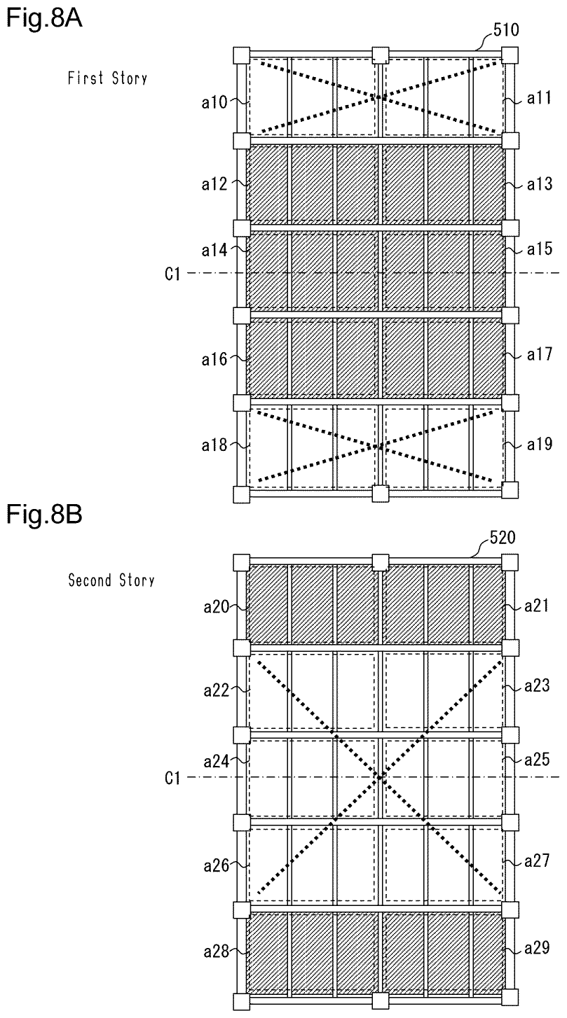

FIG. 8A shows a fourth layout option, in which the floor remaining regions are provided in the regions a12 to a17 in the first story 510. The removal regions are provided in the regions a10, a11, a18, and a19.

In the second story 520 above the first story 510, the floor remaining regions and the removal regions are reversed compared to the first story 510 as shown in FIG. 8B. Specifically, the removal regions are provided in the regions a22 to a27 in the second story 520. The floor remaining regions are provided in the regions a20, a21, a28, and a29.

In the fourth layout option, the floor remaining regions are collectively provided in the first story 510, so that the ease of maintenance is improved.

The design assistance unit 212 stores the created layout options in the layout information storage unit 24.

Next, the control unit 21 sequentially specifies processing targets in the created layout options, and repeats the following processes.

The control unit 21 executes a process of evaluating the number of placements corresponding to the removal regions (step S14). Specifically, the design assistance unit 212 calculates the floor area of the removal regions in the first story 510 and the second story 520 of the layout option to be processed. The design assistance unit 212 then obtains the unit weight of the floor from the basic information storage unit 22. Subsequently, the design assistance unit 212 calculates the weight of the removed floor by multiplying the unit weight of the floor by the floor area of the removal regions, that is, the weight reduced by the removal of the floor. The weight of the removed floor is used so as to correspond to the weight of the servers. In this regard, the design assistance unit 212 calculates the live load of the building (structural design) by performing structural calculations using the reduced weight resulting from the removal of the floor. The design assistance unit 212 then obtains the average weight of the server racks from the basic information storage unit 22. The design assistance unit 212 calculates the number of servers that can be placed (first server quantity) by dividing the live load of the building by the average weight of the server racks.

The control unit 21 then executes a process of evaluating the number of placements corresponding to the floor remaining regions (step S15). Specifically, the design assistance unit 212 calculates the floor area of the regions below the removal regions (server placement regions) in the first story 510 and the second story 520 of the layout option to be processed. Next, the design assistance unit 212 calculates the number of servers that can be placed (second server quantity) by dividing the floor area of the server placement regions by the area of a single server rack.

Next, the control unit 21 executes a comprehensive evaluation process (Step S16). Specifically, the design assistance unit 212 compares the first server quantity and the second server quantity, and specifies the smaller one as the number of servers that can be placed.

The control unit 21 repeats the above-described process until it completes for all layout options.

Next, the control unit 21 executes a process of outputting layout options (step S17). Specifically, the design assistance unit 212 outputs layout options associated with the number of servers that can be placed to the display device H13 of the user terminal 10.

In this case, a person in charge uses the user terminal 10 to review the layout options and determine the desired layout.

### Construction of Data Center

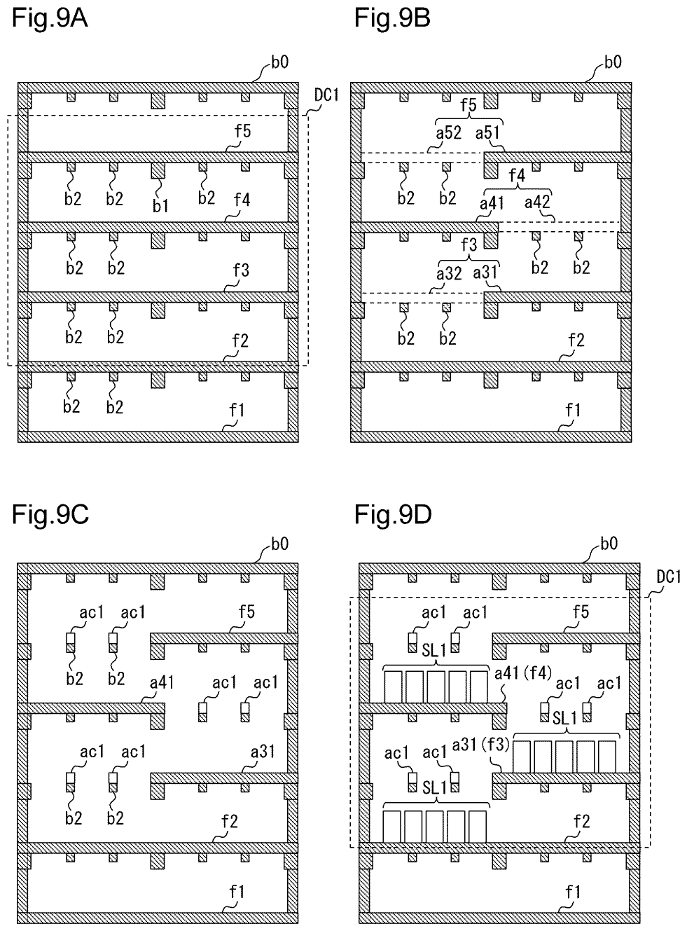

Next, the construction of a data center in an existing building will be described using FIGS. 9A to 9D.

FIG. 9A illustrates an exemplary case in which a data center DC1 is constructed in an existing building b0 that has levels f1 to f5 by placing servers in the levels f2 to f4.

First, as shown in FIG. 9B, the floor in the removal regions of the existing building b0 is removed according to the layout determined in the design process. Specifically, the floor of the floor remaining regions a31, a41, a51 is preserved, while the floor of removal regions a32, a42, and a52 is removed. In this case, the secondary beams b2 in the removal regions a32, a42, and a52 are preserved.

Next, as shown in FIG. 9C, air conditioners ac1 (air conditioning system that circulates air) are placed on the secondary beams b2 in the removal regions a32, a42, and a52.

Also, as shown in FIG. 9D, a server SL1 is placed directly below each location where the air conditioners ac1 are installed. In the present embodiment, the servers SL1 are respectively placed in a region in the level f2 that is directly below the removal region in the level f3, the floor remaining region a31 in the level f3, and the floor remaining region a41 in the level f4. As a result, the data center DC1 is constructed in the existing building b0.

In this data center DC1, the server SL1 in each story is cooled by the downflow from the upper-level air conditioners ac1.

The present embodiment has the following advantages.
(1) In the present embodiment, multiple existing office buildings b0 are renovated to construct a group of small-scale data centers.
(2) In the present embodiment, floor remaining regions and removal regions are provided in the existing building b0, and the servers are installed in the floor remaining regions. In this case, the area of the removal regions is limited to less than or equal to half of the total floor area. Since the floor is removed from the removal regions, the yield strength and the seismic performance of the existing building are maintained even when the heavy servers SL1 are placed.
(3) In the present embodiment, the area ratio between the floor remaining regions and the removal regions is determined to fall within a specified range. This allows more servers to be placed by utilizing the floor remaining regions allocated for the installation of the servers SL1 and the floor remaining regions used to reduce the load on the building.
(4) In the present embodiment, the floor remaining regions and the removal regions are arranged symmetrically with respect to the specified axis C1 passing through the center of each level. If the regions were arranged asymmetrically, the stress on the foundations and piles of the existing building would change. Therefore, it is possible to suppress uneven distribution of the weight load on the building by dispersing the floor remaining regions and the removal regions.
(5) In the present embodiment, the layout of the floor remaining regions and the removal regions is reversed between an upper story and a lower story. This allows a floor void to be provided above each server SL1, which is placed in a floor remaining region. These floor voids can be used to cool the servers SL1. By providing a removal region directly above each server SL1, the cooling of the servers SL1 and the reduction of the load on the building are achieved.
(6) In the present embodiment, the secondary beams b2 in the removal regions are preserved. The air conditioners ac1 are placed on the secondary beams b2. This allows each server SL1 to be cooled from above using the air conditioners ac1.
(7) In the present embodiment, the control unit 21 executes a process of outputting layout options (step S17). Layout options associated with the number of servers that can be placed are output. This allows the economic efficiency (cost performance) of the data center to be determined based on the number of servers that can be placed.

The above-described embodiment may be modified as follows. The above-described embodiment and the following modifications can be combined as long as the combined modifications remain technically consistent with each other.

In the above-described embodiment, the design process is executed using the user terminal 10 and the assistance server 20. The steps S11 to S17 may be performed manually.

In the above-described embodiment, the floor remaining regions and the removal regions are arranged symmetrically with respect to the specified axis C1 passing through the center of each level. If uneven distribution of weight load on the building is suppressed, it is not necessary to arrange the floor remaining regions and the removal regions symmetrically with respect to a specified axis.

In the above-described embodiment, the design assistance unit 212 calculates the live load of the building (structural design) by performing structural calculations using the reduced weight resulting from the removal of the floor. The design assistance unit 212 calculates the number of servers that can be placed (first server quantity) by dividing the live load of the building by the average weight of the server. Alternatively, the number of servers that can be installed may be calculated by dividing the reduced weight resulting from the floor removal by the average weight of servers.

Further, the number of servers that can be placed may be calculated by adding the weight of the air-conditioning system in addition to the weight of the servers to the reduced weight resulting from the floor removal.

In the above-described embodiment, the control unit 21 executes the comprehensive evaluation process (step S16). The evaluation of layout options is performed using the server quantities. The evaluation method is not limited to this. For example, the thermal load due to the heat generated by the servers in the data center may be evaluated. In this case, a thermal load simulation is performed, in which heat sources corresponding to the heat generation by the servers are placed in the floor remaining regions. In this thermal load simulation, the load (e.g., power consumption) of the air conditioners positioned above the servers is predicted to maintain the data center at a specified temperature. The control unit 21 then outputs the simulation results in association with the layout options in the layout option output process (step S17).

In the above-described embodiment, the user terminal 10 and the assistance server 20 are used. The hardware configuration is not limited to this. For instance, the user terminal 10 may include the control unit 21, the basic information storage unit 22, the building information storage unit 23, and the layout information storage unit 24, so that the design process is performed in the user terminal 10.

1. A method for constructing a data center using an existing building, the method comprising:
identifying locations of beams in a first level of the existing building in which a server is placed;
specifying layout options that include a server placement region that is surrounded by the beams and a floor removal region in a second level immediately above the first level, the floor removal region being directly above the server placement region; and
determining, in the layout options, a layout of the data center in accordance with a weight of a server placed in the server placement region and a weight of a floor in the floor removal region.

2. The method for constructing the data center according to claim 1, wherein determining the layout of the data center includes determining the layout such that a server having a weight corresponding to a yield strength of the existing building in correspondence with the weight of the floor in the floor removal region is placed in the server placement region.

3. The method for constructing the data center according to claim 1, further comprising providing an additional floor removal region in the first level.

4. The method for constructing the data center according to claim 1, further comprising using the beams in the floor removal region in the second level to provide an air conditioning system that circulates air.

5. A data center construction system comprising a circuitry configured to determine a layout for installing a server of a data center in an existing building, wherein the circuitry is configured to execute:
identifying locations of beams in a first level of the existing building in which a server is placed;
specifying layout options that include a server placement region that is surrounded by the beams and a floor removal region in a second level immediately above the first level, the floor removal region being directly above the server placement region; and
outputting the layout options in accordance with a weight of a server placed in the server placement region and a weight of a floor in the floor removal region.

6. A data center provided in an existing building, comprising:
a server placement region that is a floor region surrounded by beams in a first level in which a server is placed in the existing building; and
a floor removal region in a second level immediately above the first level, the floor removal region being a region above the server placement region and in which a floor is removed while preserving beams.
